(19) United States
(12) Patent Application Publication
(10) Pub. No.: US 2025/0262744 A1
(43) Pub. Date: Aug. 21, 2025

(54) PIPE FITTING STAND

(71) Applicant: MILWAUKEE ELECTRIC TOOL CORPORATION, Brookfield, WI (US)

(72) Inventor: Ernesto Mendez, Milwaukee, WI (US)

(21) Appl. No.: 19/053,694

(22) Filed: Feb. 14, 2025

Related U.S. Application Data
(60) Provisional application No. 63/554,631, filed on Feb. 16, 2024.

(51) Int. Cl. B25H 1/00

(52) U.S. Cl. CPC B25H 1/0042

(57) ABSTRACT

A pipe fitting stand including a table having an upper side, a lower side opposite the upper side, and a cavity at least partially defined by parallel side walls extending from the lower side of the table. The pipe fitting stand includes at least one pipe support provided on the upper side of the table and configured to support a pipe on the table, an insert received within the cavity and including an arcuate wall, and a leg coupled to the table and extending outward from the cavity, the leg having an outer peripheral surface abutting the arcuate wall.

### CROSS-REFERENCE TO RELATED APPLICATIONS

This application claims priority to U.S. Provisional Patent Application No. 63/554,631, filed on Feb. 16, 2024, the entire contents of which are incorporated herein by reference.

### FIELD OF THE INVENTION

The present invention relates to workpiece supporting stands, and more particularly to pipe fitting stands.

### SUMMARY OF THE INVENTION

The present invention provides, in one aspect, a pipe fitting stand including a table having an upper side, a lower side opposite the upper side, and a cavity at least partially defined by parallel side walls extending from the lower side of the table. The pipe fitting stand includes at least one pipe support provided on the upper side of the table and configured to support a pipe on the table, an insert received within the cavity and including an arcuate wall, and a leg coupled to the table and extending outward from the cavity, the leg having an outer peripheral surface abutting the arcuate wall.

The present invention provides, in another aspect, a pipe fitting stand including a table having an upper side, a lower side opposite the upper side, and a table cavity at least partially defined by the lower side of the table. The pipe fitting stand includes an insert received within the table cavity and including an insert cavity partially defined by an arcuate wall, the insert cavity including an open end opposite the arcuate wall, and a cylindrical leg coupled to the table and received in the insert cavity, the leg having an outer peripheral surface abutting the arcuate wall.

The present invention provides, in another aspect, a pipe fitting stand including a table having an upper side and a lower side opposite the upper side, an insert provided on the lower side of the table and including an insert cavity partially defined by a wall, the insert cavity including an open end opposite the wall, and a leg pivotably coupled to the table between a deployed state and a folded state, the leg abutting the wall in the deployed state, and the leg extending through the open end in the folded state.

Other features and aspects of the invention will become apparent by consideration of the following detailed description and accompanying drawings.

### BRIEF DESCRIPTION OF THE DRAWINGS

FIG. 1 is a perspective view of a pipe fitting stand in accordance with an embodiment of the invention, the pipe fitting stand shown in a deployed state.

FIG. 2 is a top view of a table of the pipe fitting stand of FIG. 1.

FIG. 3 is a bottom view of the table of the pipe fitting stand of FIG. 1.

FIG. 4 is a side view of the pipe fitting stand of FIG. 1 in a folded state.

FIG. 5 is an enlarged, bottom perspective view of the table of the pipe fitting stand of FIG. 1.

FIG. 6 is another enlarged, bottom perspective view of the table of the pipe fitting stand of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

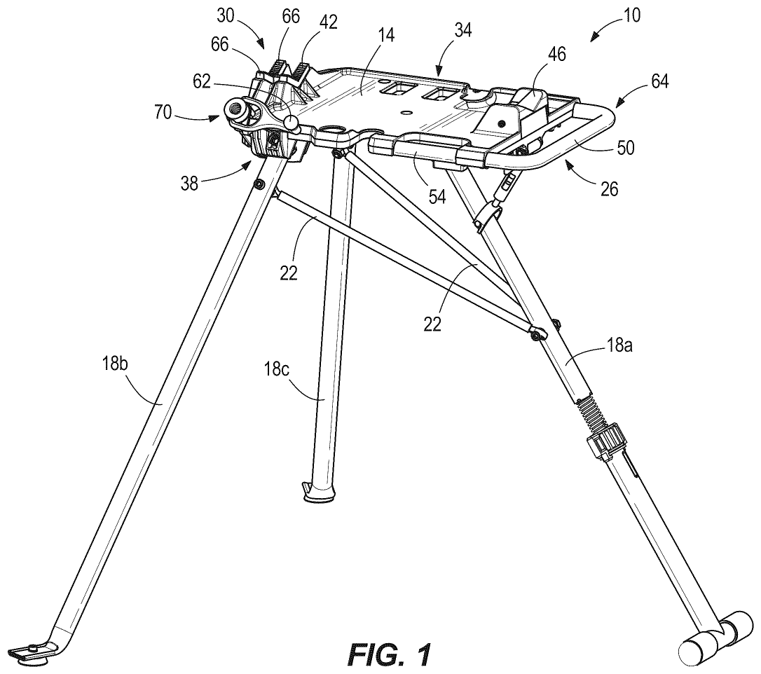

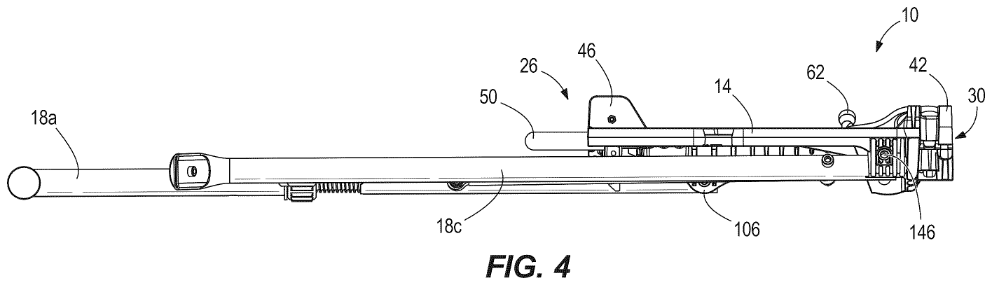

FIG. 1 illustrates a pipe fitting stand 10 for supporting a pipe during a work operation. In the illustrated embodiment, the stand 10 includes a table 14 and three legs 18a-18c extending from the table 14. The legs 18a-18c support the table 14 in an elevated position with respect to a support surface. The stand 10 also includes two links 22 pivotably coupling a first of the legs 18a, respectively, with the other two legs 18b, 18c to coordinate movement of the legs 18a-18c as the stand 10 is reconfigured between a deployed state (shown in FIG. 1) and a folded state (shown in FIG. 4). The folded state can also be referred to as a stowed state.

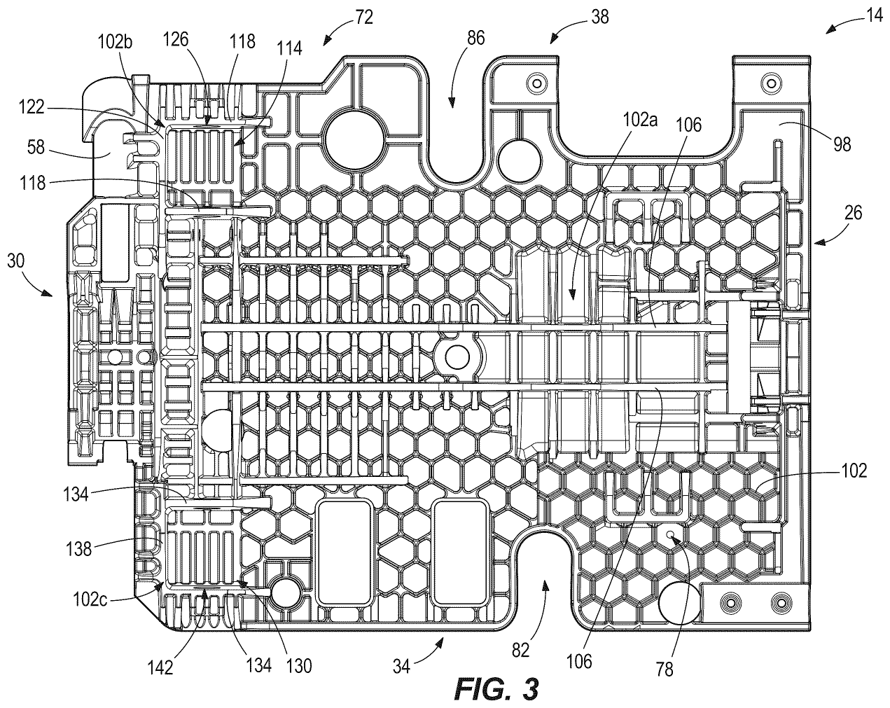

With reference to FIG. 1, the table 14 is formed as a single, monolithic component. The table 14 includes a first side 26 (also referred to as a first end 26) and a second side 30 (also referred to a second end 30) opposite the first side 26. The first side 26 is proximate the first leg 18a, and the second side 30 is proximate a second leg 18b and a third leg 18c. The table 14 also includes a third side 34 and a fourth side 38 opposite the third side 34. The third and fourth sides 34, 38 each extend between the first and second sides 26, 30. Together, the first, second, third, and fourth sides 26, 30, 34, 38 define a generally rectangular shape of the table 14. A vise 42 is positioned on the second side 30 of the table 14. The vise 42 supports and clamps a pipe (not shown) to the table 14. A support 46 is positioned on the first side 26 of the table 14. Stated another way, the support 46 is positioned on a side (or end) of the table 14 opposite the vise 42. The support 46 additionally supports the pipe. The stand 10 also includes an operating handle 50 that extends from the first side 26 of the table 14. A user can grasp the operating handle 50 during operation of the stand 10. The operating handle 50 also includes a portion that extends along the fourth side 38 of the table 14. The portion of the operating handle 50 extending along the fourth side 38 can be referred to as a side handle 54. The side handle 54 can be used during transport or operation of the stand 10. When the stand 10 is in the deployed state, tools can be stored on the operating handle 50 (including the side handle 54). The table 14 can include a supplemental grip 58 (shown in FIG. 3) positioned below the vise 42. The supplemental grip 58 can be grasped during operation. A vise handle 62 is positioned on the fourth side 38 of the table 14. The vise handle 62 is advantageously positioned on the same side of the table 14 as the side handle 54 (i.e., the fourth side 38). More specifically, when the stand 10 is carried in its folded state, the vise handle 62 is on an opposite side of the table 14 as the ground. This protects the vise handle 62 in case the stand 10 is dropped. The table 14, the handle 50, the vise handle 62, and other separate features mounted to the table 14 collectively form a table assembly 64.

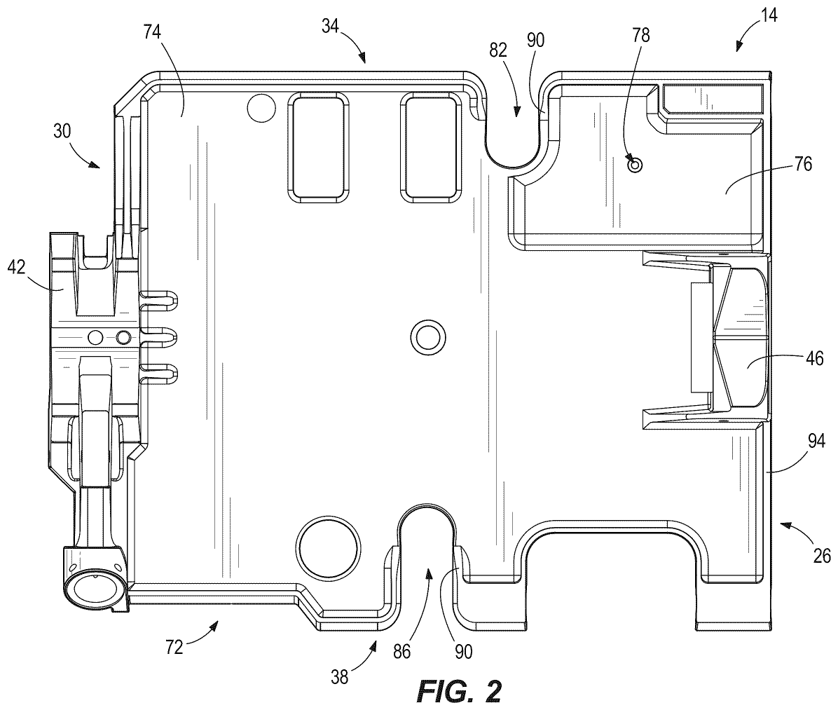

With continued reference to FIG. 1, the vise 42 includes a pair of jaws 66 for supporting the pipe and a clamp assembly 70 for applying a clamping force to (adjustably clamping) the pipe within the jaws 66. The clamp assembly 70 includes the vise handle 62 and a chain screw assembly (not shown) coupled together (e.g., by a nut). The second side 30 of the table 14 can include, for example, a cut-out 72 (shown in FIG. 2) to allow the vise handle 62 to rotate without interfering with the table 14. During use, a user may place the pipe on the jaws 66 and support 46 and wrap a chain (not shown) of the chain screw assembly around the pipe. To secure the chain, the free end of the chain is temporarily latched to the table 14 on an opposite side as the clamp assembly 70. The user then rotates the vise handle 62, thereby translating the chain screw away from the jaws 66, tensioning the chain and tightening it around the pipe.

With reference to FIG. 2, an upper side 74 of the table 14 includes a recessed tray 76 positioned adjacent the first side 26. The recessed tray 76 includes an aperture 78 extending through the table 14. During operation, the tray 76 can hold utensils (e.g., pens, pencils, etc.), and liquid may drain through the aperture 78. The table 14 also includes a first slot 82 extending through the third side 34 of the table 14, and a second slot 86 extending through the fourth side 38 of the table 14. The first and second slots 82, 86 are shaped and sized to receive a handle of a power tool (e.g., a band saw, a hammer, etc.). The first and second slots 82, 86 each include a lip 90 extending around a periphery of the slots 82, 86. The lips 90 are slanted inwardly and ramp down to be flush with the table 14, such that the lips 90 can retain the power tool handle in the slots 82, 86. Additionally, the table 14 includes a rim 94 extending around a perimeter of the table 14. The rim 94 is raised above an uppermost surface of the table 14 such that a user may hang power tools and other items on the rim 94.

With reference to FIG. 3, an underside 98 (also referred to as a lower side 98) of the table 14 includes a honeycomb structure 102, which reduces the weight and increases the strength of the stand 10. The underside 98 of the table 14 also includes a first mounting portion 102a, a second mounting portion 102b, and a third mounting portion 102c. The first mounting portion 102a is positioned in a central portion of the table 14. The first mounting portion 102a includes a pair of first walls 106 that extend between the first and second sides 26, 30 of the table 14. Each first wall 106 includes a first aperture (not shown). A first fastener (not shown) extends through each first aperture and the first leg 18a to pivotably couple the first leg 18a to the first mounting portion 102a, which is described in further detail below.

The second mounting portion 102b includes a second cavity 114 (also referred to as a second table cavity 114). The second cavity 114 is defined between a pair of second side walls 118, a second rear wall 122, and the underside 98 of the table 14. Each second side wall 118 extends from the underside 98 of the table 14 and between the first and second sides 26, 30 of the table 14. More specifically, each second side wall 118 extends perpendicular from (or normal to) the underside 98 of the table 14. The second side walls 118 are parallel with each other. As such, the pair of second side walls 118 can also be referred to as a pair of parallel second side walls 118. The second rear wall 122 extends from the underside 98 of the table 14 and between the third and fourth sides 34, 38 of the table 14. The second rear wall 122 extends perpendicular from the underside 98 of the table 14. The second rear wall 122 extends generally parallel to the second side 30 of the table 14. The second rear wall 122 is oriented perpendicular to each second side wall 118. Each second side wall 118 includes a second aperture 126. A second fastener (not shown) extends through each second aperture 126 and the second leg 18b to pivotably couple the second leg 18b to the second mounting portion 102b, which is described in further detail below.

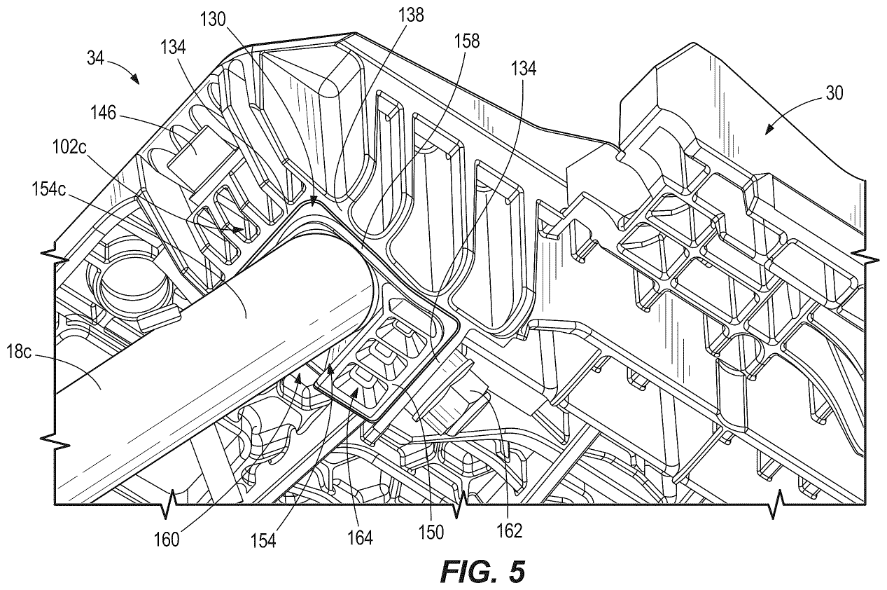

The third mounting portion 102c includes a third cavity 130 (also referred to as a third table cavity 130). The third cavity 130 is defined between a pair of third side walls 134, a third rear wall 138, and the underside of the table 14. Each third side wall 134 extends from the underside 98 of the table 14 and between the first and second sides 26, 30 of the table 14. More specifically, each third side wall 134 extends perpendicular from (or normal to) the underside 98 of the table 14. The third side walls 134 are parallel with each other. As such, the pair of third side walls 134 can also be referred to as a pair of parallel third side walls 134. The third rear wall 138 extends from the underside 98 of the table 14 between the third and fourth sides 34, 38 of the table 14. The third rear wall 138 extends perpendicular from the underside 98 of the table 14. The third rear wall 138 extends generally parallel to the second side 30 of the table 14. The third rear wall 138 is oriented perpendicular to each third side wall 134. Each third side wall 134 includes a third aperture 142. A third fastener 146 (best shown in FIG. 5) extends through each third aperture 142 and the third leg 18c to pivotably couple the third leg 18c to the third mounting portion 102c, which is described in further detail below. As shown in FIG. 2, the second and third mounting portions 102b, 102c are substantially identical. However, the second mounting portion 102b is on an opposite side of the table 14 as the third mounting portion 102c, such that the second and third mounting portions 102b, 102c are symmetrical about a longitudinal axis of the table 14.

With reference to FIGS. 1 and 4, each of the legs 18a-18c is separately pivotably coupled to the table 14 between the deployed state (shown in FIG. 1) and the folded state (shown in FIG. 4). However, as mentioned above, the links 22 interconnect the legs 18a, 18b and the legs 18a, 18c, respectively, such that pivoting movement of the leg 18a relative to the table 14 causes the other legs 18b, 18c to also pivot relative to the table 14. In the illustrated embodiment, each leg 18a-18c extends from the table 14 in a different direction when in the deployed state (i.e., each of the legs 18a-18c is non-parallel with the others and obliquely oriented relative to the table 14), and each leg 18a-18c extends from the table 14 in the same direction when in the folded state. In other embodiments, the legs 18a-18b can be aligned in a different configuration in the deployed and folded states.

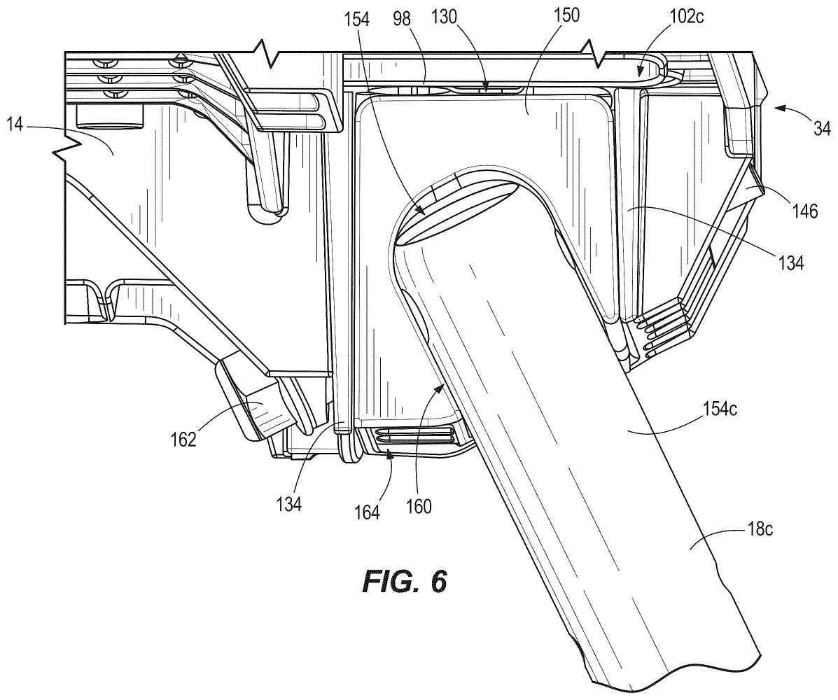

With reference to FIGS. 5 and 6, the stand 10 includes an insert 150 (also referred to as a third insert 150) received within the third cavity 130 of the third mounting portion 102c. The insert 150 is in contact with the underside 98 of the table 14, both third side walls 134, and the third rear wall 138. The insert 150 includes an insert cavity 154, which receives the third leg 18c. The insert cavity 154 is shaped to support the third leg 18c when in the deployed position to prevent the third leg 18c from pivoting beyond the deployed position shown in FIG. 5. In the illustrated embodiment, the third leg 18c extends outward from the table 14. Further, the third leg 18c extends obliquely outward from the table 14 in the deployed position. Accordingly, the insert cavity 154 extends in a similar oblique angle relative to the table 14 to support the third leg 18c. The insert cavity 154 is at least partially defined by an arcuate wall 158, and the third leg 18c includes an outer peripheral surface 154c that is in contact with the arcuate wall 158 when the third leg 18c is in the deployed position. The arcuate wall 158 is shaped similarly as the outer peripheral surface 154c of the third leg 18c. In the illustrated embodiment, the outer peripheral surface 154c of the third leg 18c is cylindrical and has a first radius. The arcuate wall 158 of the insert cavity 154 has a second radius that is nominally equal to the first radius. In some embodiments, the first and second radii can be identical. In other embodiments, the outer peripheral surface 154c and the arcuate wall 158 can have an identical curvature. In these embodiments, the support provided by the insert 150 to the third leg 18c is increased because the arcuate wall 158 contacts the third leg 18c over 180 degrees around the outer peripheral surface 154c. Stated another way, the outer peripheral surface 154c abuts the arcuate wall 158 around 180 degrees of radial contact about the third leg 18c. In other embodiments, the arcuate wall 158 and the outer peripheral surface 154c can have at least 180 degrees of radial contact (e.g., 195 degrees, 215 degrees, 270 degrees, etc.). Alternatively, the arcuate wall 158 and the outer peripheral surface 154c can have less than 180 degrees of radial contact (e.g., 90 degrees, 135 degrees, 165 degrees).

The arcuate wall 158 of the insert 150 is a closed end of the insert cavity 154. The insert cavity 154 also includes an open end 160 opposite the arcuate wall 158 (or the closed end) of the insert cavity 154. The open end 160 provides clearance for the third leg 18c to pivot. In the illustrated embodiment, the third leg 18c extends through the open end 160 when in the stowed position and is positioned away from the open end 160 when in the deployed position. In other embodiments, the third leg 18c can extend through the open end 160 when in the deployed and the stowed positions.

With continued reference to FIGS. 5 and 6, the insert 150 includes a bore (not shown) through which the third fastener 146 extends. The third fastener 146 extends through the third leg 18c, the third apertures 142, and the insert 150 to pivotably couple the third leg 18c to the table 14 and the insert 150. In the illustrated embodiment, the third fastener 146 is obliquely oriented relative to the third side walls 134 and the underside 98 of the table 14. Stated another way, the third fastener 146 extends generally perpendicular to a longitudinal axis defined by the third leg 18c. The third fastener 146 is coupled to a nut 162 (also referred to as a third nut 162) to secure the fastener 146 relative to the table 14. The insert 150 includes a plurality of recesses 164. The recesses 164 can reduce the weight and increases the strength of the insert 150. In other embodiments, the insert 150 can be a solid component (outside of the insert cavity 154). In the illustrated embodiment, the insert 150 is composed of a rigid material (e.g., plastic, steel, aluminum, etc.). In other examples of embodiments, the insert 150 can be composed of a resilient material (e.g., rubber, silicone, etc.) or a composite material.

When in the deployed state, the legs 18a-18c support the weight of the stand 10, the pipe, and any additional materials placed on the stand 10. The weight is transferred to each leg 18a-18c. If, for example, the third cavity 130 did not include the insert 150, the weight of the table 14 and any objects supported thereon would only be transferred to the third leg 18c by the third fastener 146. The third fastener 146 contacts the third leg 18c at relatively few positions. More specifically, the third fastener 146 contacts the third leg 18c at two apertures in the third leg 18c through which the third fastener 146 extends. This undesirably concentrates all the weight transfer over a small area of the third leg 18c. Beneficially, the insert 150 distributes the load applied to the third leg 18c over a larger surface, thereby reducing stress applied to the third leg 18c when the table 14 is loaded. As a result, the third leg 18c, and thus the entire stand 10, can support more weight. In some embodiments, the insert 150 can double the amount of weight that the stand 10 can support.

The stand 10 also includes a second insert (not shown) positioned within the second cavity 114 of the second mounting portion 102b. For the sake of brevity, only the third insert 150 has been described and illustrated. However, it should be appreciated that the second insert includes identical features as the third insert 150 but is symmetrical to the third insert 150 about a longitudinal axis of the table 14. The second insert is coupled to the second mounting portion 102b by a second fastener (not shown) and a second nut (not shown). The second fastener and nut are identical to the third fastener 146 and the nut 162, respectively.

Although the invention has been described in detail with reference to certain preferred embodiments, variations and modifications exist within the scope and the spirit of one or more independent aspects of the invention as described.

What is claimed is:

1. A pipe fitting stand comprising:
a table including
an upper side,
a lower side opposite the upper side, and
a cavity at least partially defined by parallel side walls extending from the lower side of the table;
at least one pipe support provided on the upper side of the table and configured to support a pipe on the table;
an insert received within the cavity and including an arcuate wall; and
a leg coupled to the table and extending outward from the cavity, the leg having an outer peripheral surface abutting the arcuate wall.

2. The pipe fitting stand of claim 1, wherein the outer peripheral surface of the leg is cylindrical and has a first radius, and wherein the arcuate wall has a second radius that is nominally equal to the first radius.

3. The pipe fitting stand of claim 2, wherein the outer peripheral surface of the leg abuts the arcuate wall around at least 180 degrees of the leg.

4. The pipe fitting stand of claim 2, wherein the outer peripheral surface of the leg abuts the arcuate wall around at least 90 degrees of the leg.

5. The pipe fitting stand of claim 1, wherein the leg is a first leg of a plurality of legs, and wherein the plurality of legs includes a second leg coupled to the table.

6. The pipe fitting stand of claim 5, wherein the cavity is a first cavity, the insert is a first insert, and the leg is a first leg, the parallel side walls are first parallel side walls, and wherein the pipe fitting stand includes:
a second cavity at least partially defined by second parallel side walls extending from the lower side of the table,
a second insert received within the second cavity and including an arcuate wall, and
a second leg extending outward from the second cavity and having an outer peripheral surface abutting the arcuate wall of the second insert.

7. The pipe fitting stand of claim 1, further comprising a fastener extending through the table, the insert, and the leg to pivotably couple the leg to the table and the insert.

8. The pipe fitting stand of claim 1, wherein the leg is pivotably coupled to the table between a deployed position and a stowed position.

9. The pipe fitting stand of claim 1, wherein the at least one pipe support includes a vise positioned at a first end of the table and an additional support positioned at an opposite, second end of the table.

10. The pipe fitting stand of claim 9, wherein the vise includes a plurality of jaws and a clamp assembly having a handle and a chain screw assembly configured to adjustably clamp the pipe against the jaws.

11. The pipe fitting stand of claim 1, wherein:
the insert includes an insert cavity at least partially defined by the arcuate wall,
the arcuate wall is a closed end of the insert cavity, and
the insert cavity includes an open end opposite the closed end through which the leg extends when in a stowed position relative to the table.

12. A pipe fitting stand comprising:
a table including
an upper side,
a lower side opposite the upper side, and
a table cavity at least partially defined by the lower side of the table;
an insert received within the table cavity and including an insert cavity partially defined by an arcuate wall, the insert cavity including an open end opposite the arcuate wall; and
a cylindrical leg coupled to the table and received in the insert cavity, the leg having an outer peripheral surface abutting the arcuate wall.

13. The pipe fitting stand of claim 12, wherein the outer peripheral surface of the leg has a first radius, and wherein the arcuate wall has a second radius that is nominally equal to the first radius.

14. The pipe fitting stand of claim 12, wherein the outer peripheral surface of the leg abuts the arcuate wall around at least 180 degrees of the leg.

15. The pipe fitting stand of claim 12, wherein the outer peripheral surface of the leg abuts the arcuate wall around at least 90 degrees of the leg.

16. A pipe fitting stand comprising:
a table including an upper side and a lower side opposite the upper side;
an insert provided on the lower side of the table and including an insert cavity partially defined by a wall, the insert cavity including an open end opposite the wall; and
a leg pivotably coupled to the table between a deployed state and a folded state, the leg abutting the wall in the deployed state, and the leg extending through the open end in the folded state.

17. The pipe fitting stand of claim 16, wherein the insert cavity extends obliquely from the table, and wherein the leg extends obliquely from the table in the deployed state.

18. The pipe fitting stand of claim 16, wherein:
the table includes parallel side walls extending from the lower side of the table,
the insert includes a bore, and
a fastener extends through the parallel side walls and the bore to pivotably couple the leg to the table.

19. The pipe fitting stand of claim 16, wherein:
the table includes a pair of side walls extending from the lower side of the table and a rear wall extending from the lower side of the table,
the rear wall extends between the pair of side walls, and
the open end of the insert is positioned opposite the rear wall.

20. The pipe fitting stand of claim 19, wherein:
the table includes a first end and a second end opposite the first end,
the rear wall is positioned adjacent the second end and oriented parallel with the second end, and
the pair of side walls are oriented perpendicular with the rear wall.
